(19) United States
(12) Patent Application Publication
(10) Pub. No.: US 2007/0213935 A1
(43) Pub. Date: Sep. 13, 2007

(54) Method and System to Display Well Properties Information

(75) Inventors: Marc Fagnou, Paris (FR); Robert Van Kuijk, Le Plessis Robinson (FR)

Correspondence Address: SCHLUMBERGER OILFIELD SERVICES, 200 GILLINGHAM LANE, MD 200-9, SUGAR LAND, TX, 77478, US

(73) Assignee: Schlumberger Technology Corporation, Sugar Land, TX (US)

(21) Appl. No.: 11/564,475

(22) Filed: Nov. 29, 2006

Related U.S. Application Data
(63) Continuation-in-part of application No. 11/321,886, filed on Dec. 29, 2005.

(51) Int. Cl. G06F 19/00

(52) U.S. Cl. 702/6

(57) ABSTRACT

A system and method to provide high quality visualization of data acquired in the three dimensions of a wellbore and to enable the visualization of the real raw data as acquired in the well along with—on the same display screen—the full interpreted version of these raw data. The method and system of the invention thus enable the users to have full and simple means to understand the nature and integrity of the various layers surrounding a cased well from the casing itself to the annular between the casing and the formation.

### CROSS-REFERENCE TO RELATED APPLICATIONS

This application is a continuation-in-part of U.S. patent application Ser. No. 11/321,886, filed Dec. 29, 2005.

### BACKGROUND OF THE INVENTION

1. Field of the Invention

The invention relates generally to a method and system for displaying on a computer graphic user interface well properties information.

2. Background Art

In a well completion, a casing or pipe is set in a wellbore, and a fill-material, typically cement, is forced into an annulus between the casing and a formation. The primary purpose of such cement is to separate oil- and gas-producing layers from each other, and form water-bearing strata.

A cased well generally includes a number of interfaces at junctures of differing materials within a wellbore. A “first interface” exists at the juncture of a borehole fluid in a casing and the casing. The casing is typically made of steel. A “second interface” is formed between the casing and annulus behind the casing. If cement is properly placed in the annulus, the “second interface” exists between the casing and the cement. A “third interface” exists between the annulus and a formation. The formation may comprise a plurality of layers, e.g., an oil-producing layer, a gas-producing layer and a water-bearing layer.

A micro-annulus may appear at the second interface, between the casing and the cement. A forming of the micro-annulus is due to a variation of pressure inside the casing. Even if the micro-annulus is present, the cement may properly seal off the layers.

However, if a void appears between the casing and the formation, the cement may fail to provide isolation of one layer from another. Fluids, e.g., oil, gas or water, under pressure may migrate from one layer to another through the void, and create a hazardous condition or reduce production efficiency. In particular, migration of water into the oil-producing layer may, in some circumstances, render a well non-exploitable. Also, migration of oil into the water-bearing layer is environmentally and economically undesirable. Thus, imaging the annulus content, and, in particular, detecting the third interface between the annulus and the formation, is of great importance for reliable determination of the hydraulic isolation of the different layers of a formation.

Another need for through-the-casing imaging exists in the process of hydraulic fracturing, which typically takes place after a well has been cased, and is used to simulate the well for production. Often, the fracturing process is accompanied by sanding, whereby certain strata of the formation release fine sand that flows through casing perforations into the well, and then up to the surface, where it can damage production equipment. This problem can be remedied if the sand-producing zones are detected as could be done, for example, with an imaging technology capable of operating through the casing.

Various cement evaluating techniques using acoustic energy have been used in prior art to investigate a description of a zone behind a thick casing wall with a tool located inside the casing. Among those prior art techniques can be found U.S. Pat. No. 3,401,773, to Synott, U.S. Pat. No. 2,538,114 to Mason, U.S. Pat. No. 4,255,798 to Havira or U.S. Pat. No. 5,763,773. U.S. Pat. No. 6,483,777 to Zeroug describes a technique wherein the quality of the cement behind the casing may be evaluated from the velocity of the wave within the annulus and/or the flexural wave attenuation. The quality, e.g., a state of the matter, may be plotted in a map as a function of depth and azimuthal angle. U.S. Pat. No. 2006-0233048-A1 describes a method wherein a combination of different acoustic modes is used for evaluating the integrity of a fill-material disposed in an annulus between the casing and a formation. These most recent techniques allow to provide three-dimensional data of the well integrity and in order to derive useful and easily understandable information from those, there is a need for using three dimensional visualization methods.

U.S. Pat. Nos. 6,862,530 and 6,917,360 depict three dimensional visualization methods. Wherein these methods, computer displays allow users to manipulate the 3D objects by rotating, translating, or zooming in and out of the displayed scenes. In addition, the computer displays may allow users to change the visual effects of the display, e.g., color, lighting, or texture mapping of the objects.

However, most of the known techniques—due to the considerable amount of resources needed to interpret and compute all the acquired data—do not offer a very satisfying quality of visualization. This is not the case when those methods are applied not to real data but to already predetermined set of parameters; which happens during oilfield engineers training sessions for example. Therefore, despite strong interest for clients to visualize “good quality” images, no current method enables to provide such based on true tool evaluation data.

### SUMMARY OF THE INVENTION

It is thus an object of the invention to provide high quality visualization of data acquired in the three dimensions of a wellbore. It is also an object of the invention to provide a method and system that enable to visualize the real raw data as acquired in the well as well as—on a same display screen—the full interpreted version of these raw data. The method and system of the invention thus enable the users to have full and simple means to understand the nature and integrity of the various layers surrounding a cased well from the casing itself to the annular between the casing and the formation.

It is thus an object of the invention to provide a method for displaying on a computer graphic user interface well properties information comprising the steps of:
displaying on the computer graphic user interface a first 3D image of well properties from a first set of raw data;
displaying on the same computer graphic user interface a second 3D image of well properties from a second set of data, said second set of data corresponding to a first processed version of the first set of raw data.

In a preferred embodiment, the method comprises the step of displaying on the same computer graphic user interface a third 3D image of well properties from a third set of data, said third set of data corresponding to a fully interpreted version of the first set of raw data.

Preferably, the method further comprises extrapolating or interpolating raw data in order to provide interpreted data points for locations wherein no raw data exist and displaying those data points on the third 3D image of well properties.

In a interesting embodiment, the method further comprises allowing the images of well properties to be graphically sliced along a plane coplanar with the wellbore axis.

In a preferred embodiment, the method comprises the step of allowing in graphically slice the first 3D image of well properties with a plurality of horizontal planes in order to produce series of cut-away cylinders and allowing said cylinders to be rotated and tile in unison so that better understanding of correlation between first 3D image and second 3D image is provided.

Additionally, the well properties comprise well integrity data and the method according to the invention further comprises the step of allowing to scan the image of well properties with a graphical object inspector, said graphical object inspector giving details about the selected portion of image.

In a preferred embodiment, the images of well properties comprise concentric cylindrical surfaces, each of said cylindrical surfaces representing a different depth of investigation. Then, the concentric cylindrical surfaces comprise a first cylindrical surface representing the borehole casing; a second cylindrical surface representing an annular of material surrounding the borehole casing and a third cylindrical surface representing the borehole formation wall.

Additionally, the method of the invention comprises the step of allowing the cylindrical surfaces to be viewed at all directions and with different display scales chosen by a human operator. Additionally, the method of the invention comprises allowing graphically removing any of the concentric cylindrical surfaces from the images of well properties.

It is also an object of the invention to provide a system for displaying on a computer graphical user interface well properties information, comprising a display and a computer operatively coupled to said display, said computer having a program comprising instructions to enable the steps of:
displaying on a screen of the display a first 3D image of well properties from a first set of raw data;
displaying on the same screen of the display a second 3D image of well properties from a second set of data, said second set of data corresponding to a first processed version of the first set of raw data.

This invention presents data that is radial in nature in varying degrees of interpretation to provide a clean feel to the interpretation. Users can view the raw data as well as partially or completely interpreted views. The user has the ability to select which views to look at, as well as the ability to manipulate the data in an intuitive way, which simulates a physical object. The data can be cut away to reveal the interior of the data. Pieces of the data can be pulled out and inspected, or removed from the display.

### BRIEF DESCRIPTION OF THE DRAWINGS

Other aspects and advantages of the invention will become apparent to those skilled in the art upon reading the following detailed description and upon reference to the drawings in which:

FIG. 1 represents a general view of a cased well environment.

FIGS. 2A and 2B represent three main 3D images displayed according to the method and system of the invention.

FIG. 3 represents an example of possible view selection made from use of the method and system according to the invention.

FIG. 4 represents a detailed view of a portion of layer.

FIG. 5 represents an “unwrapped” version of the data as can be given by the method and system according to the invention.

FIG. 6 represents display screen with contour lines.

FIG. 7 represents various cuts that can be performed in a visualized object.

FIG. 8 represents a screen wherein physical sections of layers have been removed.

FIG. 9 represents a quadrants view as provided by the method and system according to the invention.

FIG. 10 represents screen representation of well integrity data with extra levels of interpretation for missing data points.

FIG. 11 represents a screen wherein the raw data and step views are displayed.

FIG. 12 represents screen showing at the same time processed raw data, cross section and waveform views.

### DETAILED DESCRIPTION

Embodiments of this invention relate to a method for visualizing on a computer display (or piece of paper) three dimensional well properties information such as the ones provided by apparatus and method according to US-2006-0233048-A1, herein incorporated by reference. The method attaches images representing well properties information on concentric cylindrical surfaces representing different cylindrical layers representative of depth of investigation.

As presented on the preferred embodiments the method and system of the invention allow combining relevant data from a well integrity point of view. The examples show geo-resistivity data, sonic and ultrasonic data, sonic and ultrasonic cement bond index, caliper possibly with addition of further formation evaluation related data.

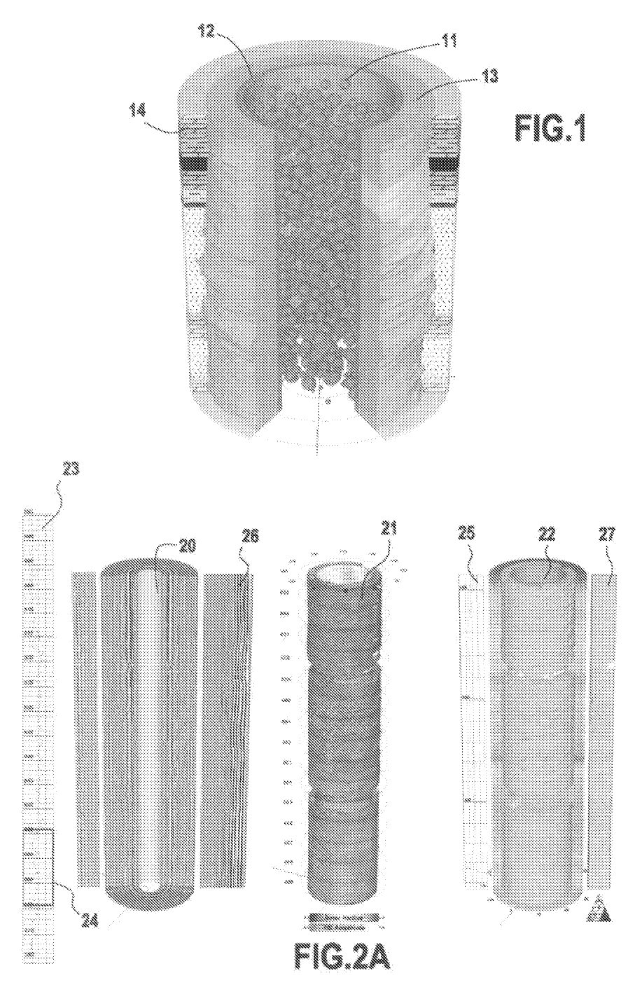

FIG. 1 gives a general presentation of the environment of a wellbore once it has been drilled and cased. On this figure, several layers and interfaces are visible from the inside of the well outwards: a well-bore/production fluid 11 that can be either water, oil, gas or a combination of both, a steel (or other) casing 12 to aid in the production and stabilize the well, a cement layer 13 to isolate one fluid producing zone from another (e.g. to isolate an oil zone from a fresh water zone) and the rock formation 14 in which the well was drilled. In some cases it is possible that any other material ensuring isolation replaces cement. In some embodiments, a second and third set of casing and cement (not shown) might be put in place. The formation can also be radially divided into several zones, for example, the invaded-zone, transition-zone, and virgin zones. All of the layers as presented on FIG. 1 can be evaluated during the life of the well and the acquired related data can be visualized using the method of the invention so that they become very easy to understand.

Data from any number of interfaces can be represented as a simulated 3D physical object on a 2D medium in both the time and special domains. In the included example of FIG. 1 and following, these interfaces are as follows and permit to see the respective material:

| Interface | Material/Solid view |
|---|---|
| Casing Inside Diameter | Borehole fluid |
| Casing Outside Diameter | Casing |
| Cement Sheath diameter | Material Behind Casing: |
| | Solid, Liquid, Gas |
| Outside Cylinder (radial | Colored and patterned by the |
| extent) | formation properties. |

For the friendly visualization and easy understanding of the user, all different materials can be built with colors, patterns, realistic representations of rocks and fluids, numbers, symbols etc . . . Further, such images can also be built using a combination of colors, patterns, realistic representation of rocks and fluids. In alternative embodiments, the system can display the value with grey scale or combination of spikes and colors.

As it can be seen on FIG. 1 and followings figures, the views are mainly vertical and not aligned with the true deviation of the wellbore. However the 3D views of the data are aligned with respect to a common rotational reference, such as the low or high side of the well obtained from a relative bearing. Furthermore the views are designed to accommodate a paper copy of the log data. Anyway, as additional possibility given by the method, scale selectors are provided that the human operator can use. The scale selectors allow the human operator to change the relative scale between the radial and axial orientations. In one embodiment of this invention (not showed), an interactive scale selector is used. The human operator can set the relative scale in the X, Y, Z directions to values of his choice in a Cartesian (or Polar) coordinate system. In such a Cartesian coordinate system, the Z direction usually represents the direction of the borehole and each of the X and Y directions represent a direction perpendicular to the Z direction and to each other. For example, at a scale of X:Y:Z=1:1:1, the borehole length would be long and slender. On the other hand, the scale to X:Y:Z=1:1:1000 would compress the length of the borehole and produce a “fatter” display that is easier to analyze.

In another embodiment of the invention, an automatic scale detector is provided for. The automatic scale selector of this invention selects a scale by comparing the length of the borehole presented in a display and the relative size of the radial distances.

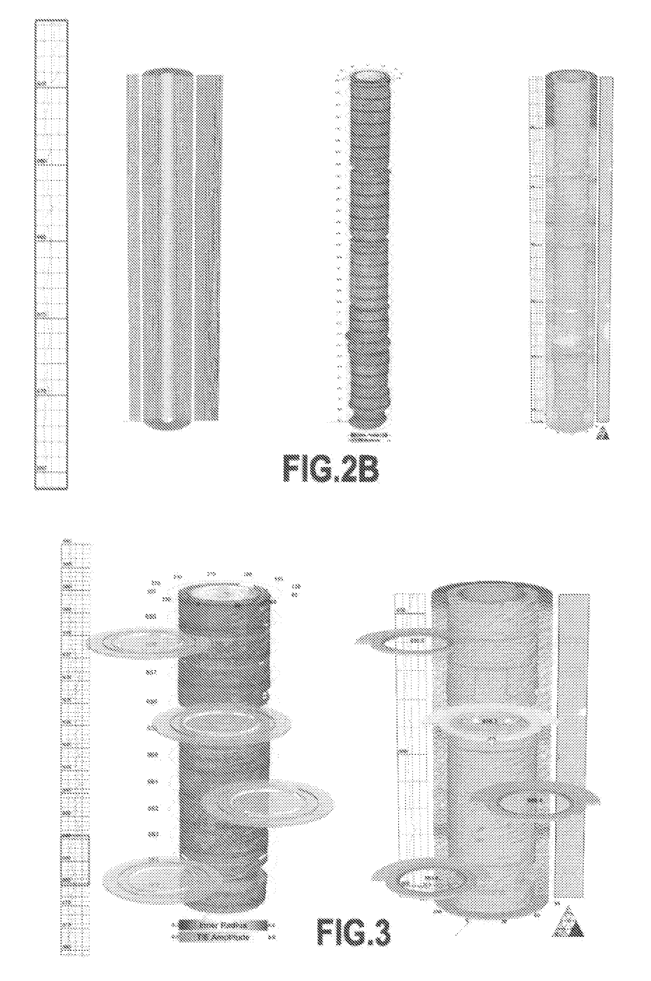

FIG. 2A represents the three main images, displayed simultaneously in three dimensions, of an example set of data. These images include from left to right one 3D well integrity raw data image 20, one 3D well integrity basic processed image 21 and one 3D well integrity final interpreted image 22. This kind of visualization is of particular importance for the user since he can simply and easily understand how the data have been interpreted, what was the initial raw data well integrity map. The first image 20 is a waveform (raw data) oriented view, which allows overlaying of processing attributes such as picks. The second processed image 21 is an interface view showing interfaces of layers that are concentrically present within the well bore. As can be seen on image 21, the casing inside diameter interface, the casing outside interface and the cement sheath interface are visible. Final interpreted image 22 is a fully interpreted radial view from logging fluid to formation. Interpreted formation is defined in this invention as any information that is derived through analysis of raw well integrity data. The user can also directly interact on the method and system according to the invention in order to modify interpretation parameters so that the final interpreted image looks closer to the reality according to the own user knowledge and field experience. Additional well integrity data shown as 2D from left to right is Gamma Ray 25 over full interval, unwrapped (helicoidal) 3D-variable density log, sonic variable density log 26, Gamma Ray over selected interval and cement bond index 27, derived from sonic and ultrasonic measurements. Not shown in this example but also relevant would be the inclusion of open hole caliper data when available.

However, despite this possibility to interact on the raw data interpretation, the method and system according to the invention are intended to provide as much convenience as possible to the human operator. Thus the system and method allow a person who has little knowledge of well logging analysis to view the well integrity data and arrive at correct conclusions. To achieve this goal, despite possibility of interaction, the method and system also allow viewing the borehole and integrity of various material layers surrounding the borehole automatically, so that a human operator does not have to input any command for the computer to continue display updated and different views of the well integrity information. In one embodiment of the invention, it is possible to implement voice recognition programs so that commands can be given to the computer by talking to a microphone that is connected to the computer system.

As presented on FIG. 2A, the 2D data 23 shown on the left side of FIG. 2A is also the main scroll bar. The window 24 can be dragged or resized by the user so that different depth according the vertical axis of the borehole can be viewed and corresponding data of that particular depth can be seen in detail. It is then also possible for the user to push back the entire view to allow for a larger vertical extend to be seen as shown on FIG. 2B.

Furthermore, the simulated physical representation can be manipulated as if it were a real object. Pieces of the object can be pulled out, inspected, and put back in place. Sections that obscure views can be removed from the display. The views can be rotated around the y-axis, and partially about the x-axis. The view rotation is limited so that it is always somewhere in between a top or side view. This assists in preventing the user from losing perception of the objects orientation.

One important advantage of the method and system according to the invention is that the application is efficient enough to be used during real time acquisition, or on common use PC's (Laptops) provided they have an appropriate graphics card.

As it can be seen on FIG. 3, a pick and play interface has been used, allowing users to interact with the data intuitively. This allows for a very streamlined user interface. As user moves the mouse over an object, a cue is given as to whether or not the object can be manipulated. As shown on FIG. 3, it is then easy for the user to select a specific section of the wellbore so that this section can be better viewed. By the way, it is possible when doing this to select which of the layers the user want to visualize among the various concentric layers existing from the wellbore, as explained earlier above.

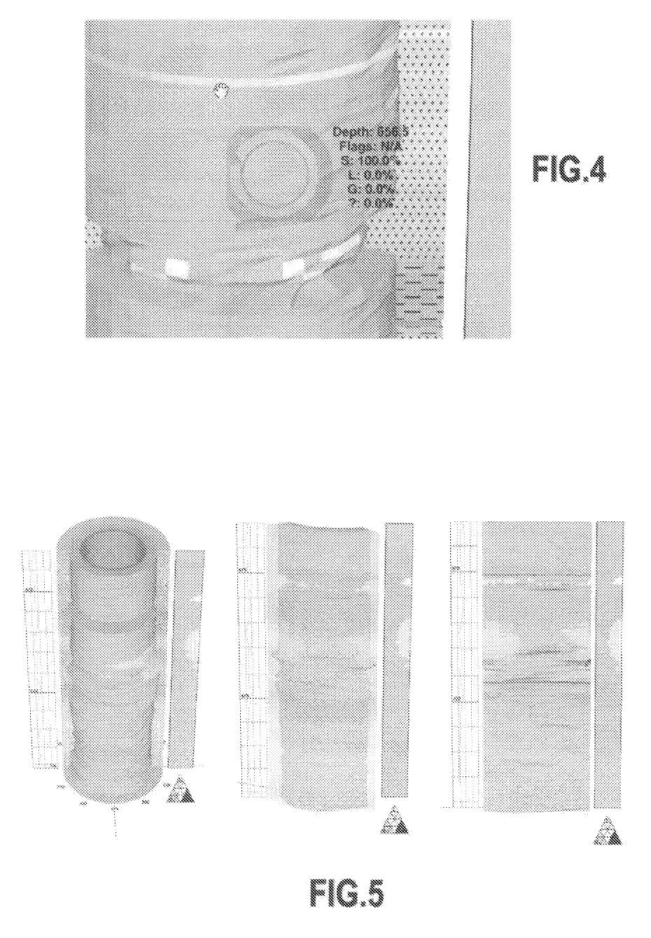

As represented on FIG. 4, the user has the option to turn on an object inspector, which will give more detail about the selected object. There can be data quality indicators, radius values etc. Details about the selected object are displayed next to it as seen on FIG. 4

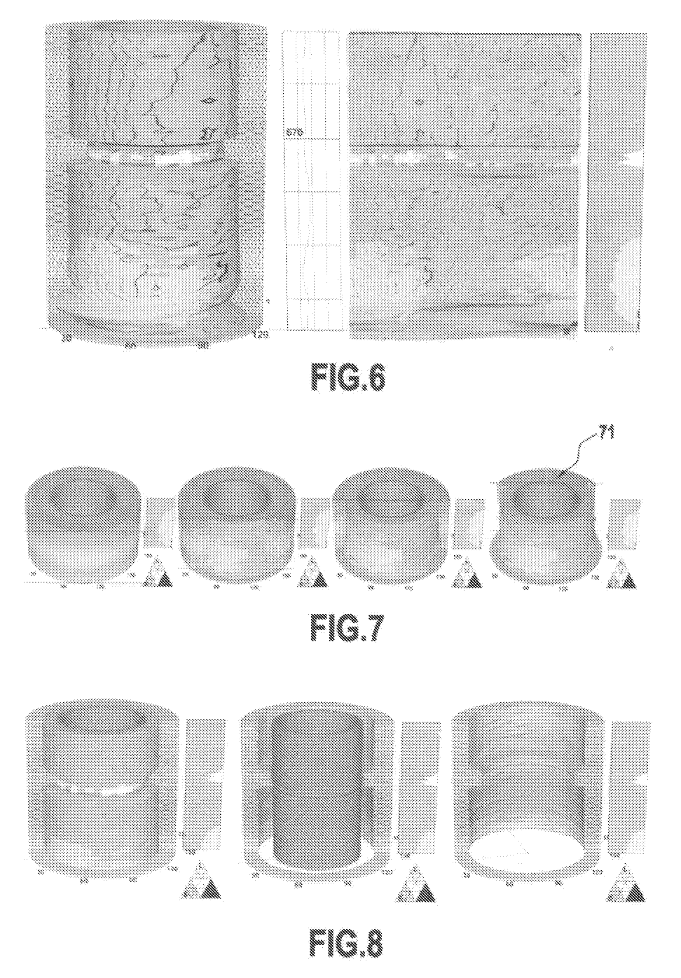

FIG. 5 represents an “unwrapped” version of the well integrity data. This view allows the user to see all sides of the object. This view is similar to the traditional form of graphical data visualization used in the oil industry called an “Image” but it retains the extra dimensions of distance. In another function given by the method and system according to the invention, contour lines can be added to the interpreted view for an extra level of detail, as showed in FIG. 6.

In order to visualize all data points, the user can cut the object vertically, to view otherwise hidden features as showed on FIG. 7. The bar 71 indicates to the user what type of cut will be made so that precise and progressive views can be performed. Physical sections of the interpreted data can also be removed so that additional features can be seen. As represented on FIG. 8, it is then possible for the user to, for example, selectively remove the material filing the annulus between the formation and the casing in a first time and then to remove also the casing so that the formation behind can be better viewed.

The method and system according to the invention allow the human operator to either manually or automatically adjust the radial distance tat is presented. For example, in an automatic operated mode, the display would begin by showing the borehole and surrounding layers to a radial distance of 12 inches; after a few seconds, the data information between radial distance of 12 to 24 inches would appear, then from 24 to 36 inches and so forth. This feature gives the human operator another method by which to appreciate how the well integrity data change spatially. The human operator can adjust the duration of time within which a specific display is shown.

As seen on FIG. 9, the method and system according to the invention also allow providing screen image wherein the various layers are divided into four sectors by intersecting planes and each sector can be moved away from the other sector. As showed on this figure, one out of the four sectors has been removed. In this configuration, a human operator would be able to see clearly images when sectors are moved away. Moreover, the system and method according to the invention allow the sectors to be moved to different locations and viewed from different angles based on instructions from a human operator.

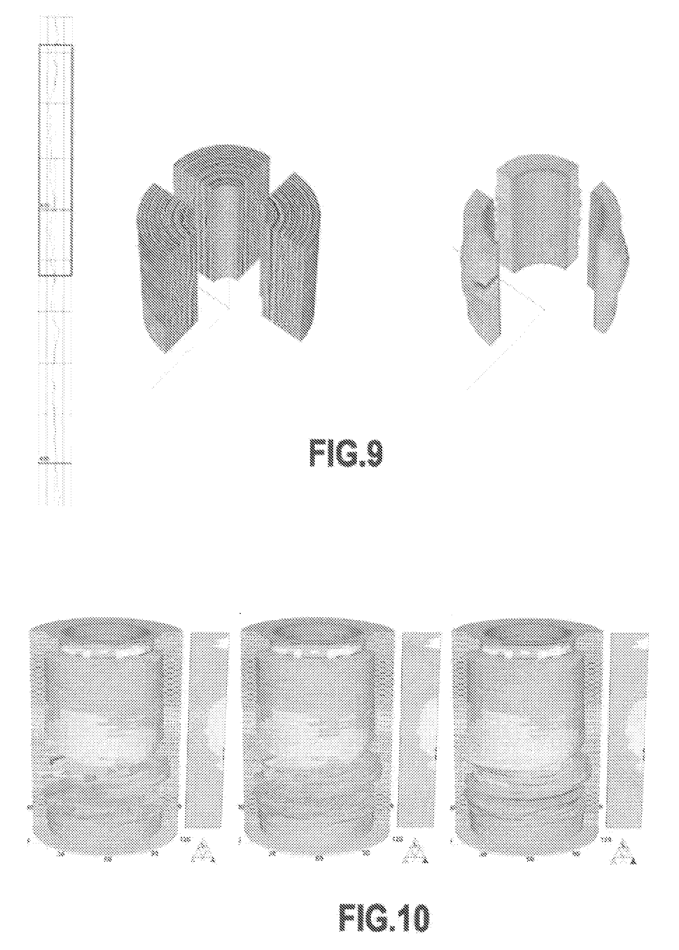

The method and system according to the invention also permits to provide the user with different levels of interpretation for missing data points. As showed on FIG. 10, various steps are given for interpretation of a same location wherein data points are missing. It gives opportunity for the user to use his own experience to estimate accuracy of the interpreted part and eventual need for change within the interpretation parameters so that the end result is closer to the user's feeling of how the image should be regarding his knowledge.

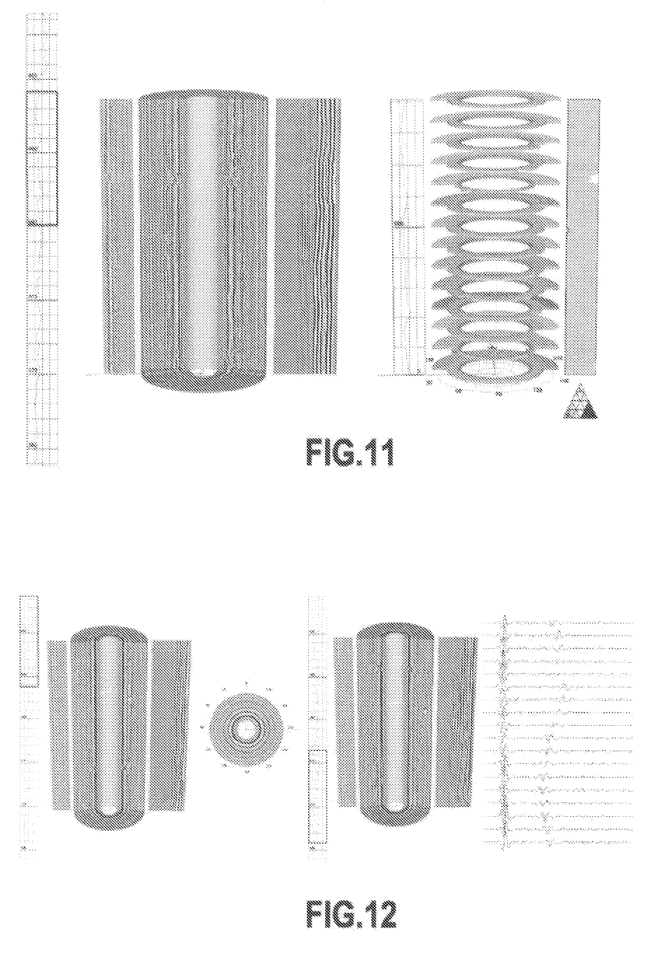

As showed on FIG. 11, when viewing the raw radial data, it is presented on a cut-away cylinder so that the user can rotate through all data points in order to get a better mental picture of how the interpretation will take place. All views rotate and tile in unison, allowing making quick correlations between the raw data and the final interpretation.

In a preferred embodiment of the method and system according to the invention, if any additional data is available (non radial in nature), it can be presented along with the 3D views to allow an increased level of interpretation or data correlation. As an example, this could be production log data, which will give an indication of the type and properties of the fluid inside the casing (as showed briefly on FIG. 1). Shown in several of the figures are formation properties, as well as cement evaluation data from different type of equipments among acoustic and/or electric imaging tools, production logging tools. Therefore, some 2D data is presented along with the 3D representation. Then, to the right of the interpreted view, a summary of all azimuths is represented; which helps a user to know if there is something of interest behind the 3D object, which is not in view. Finally, the azimuthal reference point (sample #0) is presented as a transparent plane, which does not interfere or obscure the data being viewed.

In an embodiment of the invention represented on FIG. 12, in addition to the 3D views, the data can also be inspected using one of either 2D or cross-sectional views. The raw data can be enhanced with processing indicators to allow for quality control of the interpretation.

In other embodiment of the method and system according to the invention it is also possible to link with other existing viewing 2D methods like the commercial Schlumberger (2D) viewer called DataView™. This viewer is best used for viewing single point, and global measurements such as geo-resistivity or average casing thickness. When scrolling through the 2D data in DataView™, the 3D view of displayed according to method and system of this invention will scroll to match, and display the radial data as a simulated 3D object, and vice versa. In this way, there is an ability to view many different forms of data at once. In another embodiment, the 2D could be sent directly to the method and system according to this invention so that only one file would need to be loaded.

In another embodiment, the method and system of the invention could allow the visualization of more features such as formation dip. Using dip planes or by tilting the “formation” a user would be able to quickly see the value in the data. Also, if a crucial piece of evaluation is not available, it would be very obvious from the missing section of the drawing. As an example, if a cement evaluation log had not been run, it could be possible to have a view similar to the center view of FIG. 8. Once the cement evaluation was run, the data could be loaded, and the picture completed. Furthermore, the method and system according to the invention allows the human operator to either manually or automatically view data taken from different logging trips over a period of time. For a example, formation fluid properties may have changed over the production history of the well or so for the well integrity data. These different well logging trips would produce different data properties. In an automatically operated mode, the display would begin by showing the data taken during the first logging trip for a few seconds, then the data taken during the second logging trip for a few seconds and then the data taken during a third logging trip. This would allow the human operator to visually appreciated how the well integrity information has changed as times goes on. In an interesting application of such embodiment, the method and system according to the invention could be used for monitoring the well integrity in the context of CO2 storage (wherein CO2 is particularly corrosive). In another application, visualization of data from logging with and without casing pressure applied (pressure pass) would help in discrimination of micro-annulus. Similarly visualization of data before and after squeezing would help in the determination if successful hydraulic isolation has been achieved.

Despite it has been referred to well integrity data in most part of this description, the method and system according to the invention are also suitable for displaying any type of information data related to wellbore properties. Formation properties can then also be displayed with the method and system according to the invention. These could include, non limitatively, geological formation properties like formation porosity, resistivity, density velocity, composition, grain structure, permeability, fluid saturation, temperature, pressure etc. The data could also include deep formation information like tri-axial induction, cross-well electromagnetic imaging, borehole seismic and acoustic imaging, compressional radial differences etc . . .

The foregoing description of the preferred and alternate embodiments of the present invention has been presented for purposes of illustration and description. it is not intended to be exhaustive or limit the invention to the precise example described. many modifications and variations will be apparent to those skilled in the art. the embodiment were chosen and described in order to best explain the principles of the invention and its practical applications, thereby enabling others skilled in the art to understand the invention for various embodiments and with various modifications as are suited to the particular use contemplated. it is intended that the scope of the invention is defined by the accompanying claims and their equivalents.

1- A method for displaying on a computer graphic user interface well properties information comprising the steps of:
displaying on the computer graphic user interface a first 3D image of well properties from a first set of raw data;
displaying on the same computer graphic user interface a second 3D image of well properties from a second set of data, said second set of data corresponding to a first processed version of the first set of raw data.

2- The method according to claim 1, comprising the step of displaying on the same computer graphic user interface a third 3D image of well properties from a third set of data, said third set of data corresponding to a fully interpreted version of the first set of raw data.

3- The method according to claim 2, further comprising extrapolating or interpolating raw data in order to provide interpreted data points for locations wherein no raw data exist and displaying those data points on the third 3D image of well properties.

4- The method according to claim 1, further comprising allowing the images of well properties to be graphically sliced along a plane coplanar with the wellbore axis.

5- The method according to claim 1, wherein the well properties comprise well integrity data.

6- The method according to claim 1, further comprising the step of allowing to scan the image of well properties with a graphical object inspector, said graphical object inspector giving details about the selected portion of image.

7- The method according to claim 1, wherein the images of well properties are displayed on concentric cylindrical surfaces, each of said cylindrical concentric surfaces representing a different depth of investigation.

8- The method according to claim 7, further comprising the step of allowing to graphically slice the first 3D image of well properties with a plurality of horizontal planes in order to produce series of cut-away cylinders and allowing said cylinders to be rotated and tile in unison so that better understanding of correlation between first 3D image and second 3D image is provided.

9- The method according to claim 7, further comprising the step of allowing the cylindrical surfaces to be graphically unwrapped so as to produce the images of the well properties in two dimensions.

10- The method according to claim 7, wherein the concentric cylindrical surfaces comprise:
a first cylindrical surface representing the borehole casing;
a second cylindrical surface representing an annular of material surrounding the borehole casing;
a third cylindrical surface representing the borehole formation wall.

11- The method according to claim 7, further comprising the step of allowing the cylindrical surfaces to be viewed at all directions and with different display scales chosen by a human operator.

12- The method according to claim 7, further comprising allowing graphically removing any of the concentric cylindrical surfaces from the images of well properties.

13- The method according to claim 7, further comprising allowing the well properties information displayed on concentric cylindrical surfaces to be displayed so that said well properties information on one of said cylindrical surfaces correspond to raw data acquired at a first time period and well properties information on another of said cylindrical surfaces correspond to raw data acquired at another time period.

14- The method according to claim 1, further comprising allowing to display on the first, second or third 3D images data representative of 2D well properties, i.e. data that are non-radial by nature.

15- A system for displaying on a computer graphic user interface well properties information, comprising a display and a computer operatively coupled to said display, said computer having a program comprising instructions to enable the steps of:
displaying on a screen of the display a first 3D image of well properties from a first set of raw data;
displaying on the same screen of the display a second 3D image of well properties from a second set of data, said second set of data corresponding to a first processed version of the first set of raw data.

16- The system according to claim 15, wherein said computer program further comprises the step of displaying on the same screen of the display a third 3D image of well properties from a third set of data, said third set of data corresponding to a fully interpreted version of the first set of raw data.

17- The system according to claim 16, wherein said computer program further comprises extrapolating or interpolating raw data in order to provide interpreted data points for locations wherein no raw data exist and displaying those data points on the third 3D image of well properties.

18- The system according to claim 15, wherein said computer program further comprises allowing the images of well properties to be graphically sliced along a plane coplanar with the wellbore axis.

19- The system according to claim 15, wherein images of the well properties comprise well integrity data.

20- The system according to claim 15, wherein said computer program further comprises the step of allowing to scan an image of well properties with a graphical object inspector, said graphical object inspector giving details about the selected portion of image

21- The system according to claim 15, wherein the images of well properties comprise concentric cylindrical surfaces, each of said cylindrical surfaces representing a different depth of investigation.

22- The system according to claim 21, wherein said computer program further comprises the step of allowing to graphically slice the first 3D image of well properties with a plurality of horizontal planes in order to produce series of cut-away cylinders and allowing said cylinders to be rotated and tile in unison so that better understanding of correlation between first 3D image and second 3D image is provided.

23- The system according to claim 21, wherein said computer program further comprises the step of allowing the cylindrical surfaces to be graphically unwrapped so as to produce the images of the well properties in two dimensions.

24- The system according to claim 21, wherein the concentric cylindrical surfaces comprise:
a first cylindrical surface representing the borehole casing;
a second cylindrical surface representing an annular of material surrounding the borehole casing;
a third cylindrical surface representing the borehole formation wall.

25- The system according to claim 21, wherein said computer program further comprises the step of allowing the cylindrical surfaces to be viewed at all directions and with different display scales chosen by a human operator.

26- The system according to claim 21, wherein said computer program further comprises allowing graphically removing any of the concentric cylindrical surfaces from the images of well properties.

27- The system according to claim 21, wherein said computer program further comprises the step of allowing the well properties information displayed on concentric cylindrical surfaces to be displayed so that said well properties information on one of said cylindrical surfaces correspond to raw data acquired at a first time period and well properties information on another of said cylindrical surfaces correspond to raw data acquired at another time period.

28- The system according to claim 21, further comprising the step of allowing to display on the first, second or third 3D images data representative of 2D well properties, ie. data that are non-radial by nature.
